(19) United States
(12) Patent Application Publication
(10) Pub. No.: US 2008/0188261 A1
(43) Pub. Date: Aug. 7, 2008

(54) Mediated social network

(76) Inventor: Miles Arnone, Sherborn, MA (US)

Correspondence Address: WOLF GREENFIELD & SACKS, P.C., 600 ATLANTIC AVENUE, BOSTON, MA, 02210-2206, US

(21) Appl. No.: 11/891,070

(22) Filed: Aug. 8, 2007

Related U.S. Application Data
(60) Provisional application No. 60/899,309, filed on Feb. 2, 2007.

(51) Int. Cl. H04Q 7/20

(52) U.S. Cl. 455/550.1

(57) ABSTRACT

An extension of electronically-defined social networks to include geographic location information of the user is provided. The geographic location information is integrated with user preferences to enable user-to-user contacts and/or the provision of general or specific user information mediated by the social network. In some embodiments, users may create a “virtual presence” to discover matches with other users.

### RELATED APPLICATION

This application claims the benefit under 35 U.S.C. §119(e) to U.S. Provisional Application Ser. No. 60/899,309, entitled “Mediated Social Network”, filed on Feb. 2, 2007, which is incorporated by reference herein in its entirety.

### FIELD OF INVENTION

The invention relates generally to electronic social networks, and more specifically to electronic social networks which use a geographic location of a user as a parameter.

### SUMMARY

Embodiments of the invention are directed to the extension of electronically-defined social networks to include geographic location information of the user. The geographic location information may be integrated with user preferences to enable mediated user-to-user contacts and/or the provision of general or specific user information.

According to one embodiment of the invention, a method is provided including an act of indicating via a user interface at least one of a plurality of characteristics of a first user and a plurality of preferences of a first user. The method further includes indicating a first geographic location associated with the characteristics and/or preferences of the first user, indicating a first time associated with the first geographic location, and indicating whether the first user's physical presence is associated with the first geographic location at the first time. Additionally, the method includes facilitating communication of the plurality of the first user's characteristics and/or the plurality of the first user's preferences, the first geographic location, and the first time to a matching module. The matching module is configured to compare: the first geographic location, the first time, and at least one of: a) the first user's preferences; and b) the first user's characteristics, to a second geographic location of a second user, a second time associated with the second geographic location, and at least one of preferences and characteristics of a second user, in order to determine whether a match exists between the first user and the second user.

According to another embodiment of the invention, an electronic social network system includes a preferences module configured to receive preferences of a first user and a characteristics module configured to receive characteristics of a second user. The system further includes a locations module configured to receive, from the first user, a first geographic location associated with the preferences of the first user, and a first time associated with the first geographic location. The locations module is configured to further receive, from the second user, a second geographic location associated with the characteristics of the second user, a second time associated with a the second geographic location, and an indication as to the second user's actual physical presence at the second geographic location at the second time. A matching module is included and is configured to determine whether a match exists between the first user and the second user, wherein the determination includes comparing the preferences of the first user to the characteristics of the second user, and comparing the first geographic location and the first time to the second geographic location and the second time.

According to a further embodiment of the invention, a method includes an act of indicating, via a user interface, at least one of a plurality of characteristics of a first user and a plurality of preferences of the first user. The method further includes an act of indicating a first geographic location associated with the characteristics and/or preferences of the first user, an act of indicating a first time associated with the first geographic location, and an act of indicating a second geographic location associated with the characteristics and/or preferences of the first user, the second geographic location being different from the first geographic location. An act of indicating a second time associated with the second geographic location is also included, with the second time overlapping with the first time. The act further includes facilitating one or more communications to a matching module, the one or more communications comprising the characteristics of the first user and/or the preferences of the first user, the first geographic location, the first time, the second geographic location, and the second time. The matching module is configured to compare the first geographic location, the first time, the second geographic location, the second time, and the characteristics and/or the preferences of the first user to characteristics and/or preferences of a second user, a third geographic location associated with the characteristics and/or preferences of the second user, and a third time associated with the third geographic location. The matching module is further configured to simultaneously maintain the first geographic location and the first time, and the second geographic location and the second time as actively available for comparison to at least the third geographic location and the third time.

According to yet another embodiment, an electronic social network system includes a receiving module configured to receive: indications of at least one of a plurality of characteristics of a first user and a plurality of preferences of the first user; a first geographic location associated with the characteristics and/or preferences of the first user; and a first time associated with the first geographic location. The receiving module is configured to further receive a second geographic location associated with the characteristics and/or preferences of the first user, the second geographic location being different from the first geographic location, and a second time associated with the second geographic location, the second time overlapping with the first time. The system also includes a matching module configured to compare the first geographic location, the first time, the second geographic location, the second time, and the characteristics and/or the preferences of the first user, to characteristics and/or preferences of a second user, a third geographic location associated with the characteristics and/or preferences of the second user, and a third time associated with the third geographic location. The matching module is configured to simultaneously maintain the first geographic location and the first time, and the second geographic location and the second time as actively available for comparison to at least the third geographic location and the third time.

According to yet another embodiment, a method is provided including an act of indicating via a user interface at least one of a plurality of characteristics of a first user and a plurality of preferences of a first user. The method also includes indicating a first geographic location associated with the characteristics and/or preferences of the first user. The method additionally includes an act of indicating that, in a case where a match is determined to exist between the first user and a second user, a communication should not be sent to the second user regarding the first user. The method also includes, in a case where a match is determined between the first user and the second user, receiving a communication regarding the second user. In this embodiment, a match comprises a positive result of an analysis of the first geographic location, the characteristics and/or preferences of the first user, a second geographic location of the second user, and the characteristics and/or preferences of the second user.

According to another embodiment, an electronic social network system includes a receiving module configured to receive: an indication of at least one of: a) a plurality of characteristics of a first user; and b) a plurality of preferences of a first user; an indication of a first geographic location associated with the characteristics and/or preferences of the first user; and an indication that in a case where a match is determined to exist between the first user and a second user, a communication should not be sent to the second user regarding the first user. Included in the system is an analysis module to be used as part of determining whether a match exists, the analysis module being configured to analyze the first geographic location, the characteristics and/or preferences of the first user, a second geographic location of the second user, and the characteristics and/or preferences of the second user. The system also includes a communication module configured to send a communication regarding the second user to the first user in a case where a match is determined between the first user and the second user.

In yet another embodiment of the invention, a portable system is provided for use as part of a social network system. The portable system includes a location positioning device, used as a part of positioning system, to provide the location of the location positioning device to a main server. The portable system also includes a communication device configured to communicate with the main server, and an interface with the communication device configured to receive: indications of a first geographic location associated with characteristics and/or preferences of a first user; a first time associated with the first geographic location; and whether the first user's physical presence is associated with the first geographic location at the first time.

According to a further embodiment of the invention, a portable system is provided for use as part of a social network system, the social network system including a main server that is configured to determine whether a match exists between various users based on the locations of the users. The portable system includes a location positioning device, used as a part of positioning system, to provide the location of the location positioning device to a main server. The portable system further includes a user interface configured to receive an indication that in a case where a match is determined to exist between the first user and a second user, a communication should not be sent to the second user regarding the first user. Also included is a communication device configured to send the indication to the main server and further configured to receive a communication from the main server in the case of a match being determined to exist between the first user and a second user.

### BRIEF DESCRIPTION OF DRAWINGS

The accompanying drawings are not intended to be drawn to scale. In the drawings:

FIG. 1 shows one embodiment of a system which may be used to implement a mediated social network;

FIG. 2 is a flowchart of a method according to one embodiment of the invention;

FIG. 3 illustrates one embodiment of a social network system and data received by the system;

FIG. 4 is flow chart of another method according to one embodiment of the invention;

FIG. 5 illustrates one embodiment of a social network system and data received by the system;

FIG. 6 is a flowchart of a method according to a further embodiment of the invention; and

FIG. 7 illustrates another embodiment of a social network system and data received by the system.

### DETAILED DESCRIPTION

Embodiments of the invention are directed to the extension of electronically-defined social networks to include geographic location information of the user, and also to the integration of this geographic location information with user preferences to enable user-to-user contacts and/or the provision of general or specific user information. In some embodiments, one or more of present geographic location information, past geographic location information, and indicated future geographic location information is used. In some embodiments, a user-to-user contact may be a person-to-person contact, and in other embodiments, a user-to-user contact may be a business-to-person contact. A feature allowing a user to create a “virtual physical presence” also may be incorporated into various embodiments, as is discussed further below.

As with many social networking platforms, contacts and/or affinities may be established by matching user preferences and/or characteristics with the preferences and/or characteristics of other users. In embodiments of the present invention, a social network system includes a presence engine (such as, for example, a presence software module) which keeps track of the physical locations of users, and the physical locations are used as part of the preferences and/or characteristics. A user may carry a mobile device (or use a personal computer at a fixed location) and establish links with the user's friends and potentially additional users who are not defined as friends. The system may further include a demographic profile engine that stores preference information provided by the user as well as a history of their physical locations, requests, interactions, and so on.

In some embodiments, a match of a preference to characteristics may result in the system making users visible to one another. Individual users may control their visibility or potential visibility by making themselves visible or invisible to various classes of users (persons and/or businesses) as a function of various variables including, but not limited to, gender, age, interests, geographic location, velocity, time, date, connectivity status (e.g., friend, friend-of-a-friend, desired activities, etc.), nature of a business, membership within a certain discussion group, and the number of degrees of separation between users, among others.

When users become visible to one another, notices may be sent among the users as to the presence of the various users. The notice may simply be an indication of the physical location or proximity of a certain user, or may include information regarding common interests or activity requests. For example, a user could go to a basketball court and make himself visible on the network as being interested in playing basketball. He may further define what class or classes of people to be considered as a match. For example, he may instruct the system to look for users within three degrees of separation (i.e., friend of a friend of a friend or closer) who are within three miles of the court and have defined basketball as one of their interests. When matches are found, the person at the basketball court may be provided with a list of the visible users such that he can contact the users, whether individually or as a group. In some embodiments, a user may be provided with more general information, for example, the total number of matches found, but limited or no information regarding the users themselves. A message or other communication could then anonymously be sent to the group as a whole by the user.

Requesting information regarding the presence of matched users, as in the above example, is considered to be a “pull”. Another option for establishing contact between users is a “push”. With a push, a user can push notices (e.g., voice, text, e-mail, images) or directly connect (e.g., via a mobile device) to other users as a function of variables (preferences, characteristics, specific requests, etc.). In the above example regarding basketball, instead of (or in addition to) the user at the court being provided with a list of matching users, the system may automatically send a notice to the matched users. The notices may be mediated by the network system so as to not directly expose the identity or physical location of one user to another until both users consent to such information being provided.

The notices sent to users may have a shelf life after which the notices expire and cease to be active or are automatically deleted. The length of the shelf life of a notice may be defined by the user pushing the notice. While a notice is active, a user who switches to a visible state from an invisible state or an off state may receive the notice upon the switch in state.

When a user has made himself “invisible”, he is not visible to other users or businesses. The invisible user may still receive notice as to the presence of other users (e.g., persons or businesses) that meet certain criteria and/or other users who are seeking users with their characteristics. For example, a first user could be informed of the presence of a 25-30 year-old female who likes yoga and is within 500 feet of the first user because the first user has identified this class of users as being of interest. For the user to be permitted to receive this information, the 25-30 year-old female would have to have explicitly allowed herself to be visible to users who are within the class of users of which the first user is a part and have made themselves invisible. If the 25-30 year-old female does not opt in to being visible to invisible users, an invisible party will not see her even if she matches the invisible party's desired profile. In some embodiments, a certain level of visibility may still be provided even when a user chooses an invisible state. For example, even when a user switches to an invisible state, a business may still be notified that a person meeting certain characteristics is within a certain proximity, but the business may have no way to contact that person or receive further information about that person.

In an “off” state, not only is a user invisible, he cannot send or receive notices.

When a user is visible to businesses, the system may operate in one or more of several modes (e.g., a “push mode” and a “pull mode”) which may have been previously specified by users. In a push mode, select partners can inform the user, even absent a specific request from the user, that a relevant business is nearby and the user can subsequently access relevant directions and, at the discretion of the business, a pertinent offer, such as a coupon or discount offer. Businesses may use demographic information provided by the system in conjunction with a bidding scheme to pay for these communications. For example, a user may be informed whenever he or she is within one mile of a certain brand of donut shop. Such a notice to the person is considered to be a “push”. The system may be configured to have a limit as to the number of notices that are pushed to a user in a given unit of time. In some embodiments, users who accept visibility to push notices from businesses may receive reduced or eliminated payments for subscription to the social network. The limit as to the number of push notices which the user receives may be tied to the particular discount that the user receives.

Push notices also may be provided based on other types of information. For example, the user's history of find requests, which are described below with regard to a pull mode, may be used to generate push notices. In another example, a user's present find request for a certain type of business may result in push notices being received from a different type of business. For example, a user who enters a find request for a gym may receive a notice as to a sporting goods store that is in close physical proximity to a local gym. In another configuration, businesses may send notices to users who are within a certain radius of a given location that is not necessarily the address of the business. For example, a retail store selling hockey equipment may send notices to users who come within 100 yards of a specific hockey rink that is two miles from the store. In another example, a retail store may send a push notice to a user who comes within 50 yards of a competitor's store.

In a pull mode, the user can find a business of interest by entering a find request for the system to find, for example, a coffee shop or a gym. The resulting notice(s) sent to the user is considered to be a “pull”. In some embodiments, businesses may bid (either in real-time or prior to pull requests being handled) to be the presented result or one of a plurality of presented results. The bidding could occur in some cases with knowledge about certain demographics of the user. A promotion, offer or coupon could be sent to the person as part of the notification.

In some embodiments, the user may specify for each or all of the user's profiles whether the user's characteristics and/or data are available for use for commercial purposes. In some embodiments, the user may select whether general data, that is, data which does not include the user's name, address, telephone number, etc., may be made available to commercial entities that wish to collect and/or analyze such data. For example, data collected from multiple users may be used to prepare market summaries and/or implement targeted marketing. According to some embodiments, the availability of such data may be specified by a user by turning a state on or off independently of other states such as a visible/invisible state.

Find requests to find a certain business or class of businesses may be implemented through a partnership with a telephone directory company or other substantive local or national business directory systems. The business directory systems may sell participation in the social networking system as part of their overall sale. Or, in some implementations, the business directory systems may set up a bidding system for the businesses. The social networking system may be integrated on a local market-by-market basis in some embodiments.

In another implementation, a person's own preferences may define which businesses among several matches receive top billing. For example, a certain brand of donut shop or coffee shop may be listed as preferred by the user such that these businesses are presented first when a donut shop or a coffee shop is requested, and only in the absence of these brands would an alternative be presented.

Beyond the active command to find a specific business type or other entity as in the example above, in some cases a user may set up several “permanent” find requests that persist until changed or shut off. Whenever the user is within a selected distance of the entity, information is pushed to the user. For example, in the real estate market, a user could set up a preference to be informed of houses for sale between $400,000 and $500,000 with 3+ bedrooms and 1+ acres, anytime such a property is within one kilometer of the user's current location. Or, the search could be limited to homes as described above, but only when the user is within one kilometer of the house and the user is in a certain town.

In some embodiments, a ratings systems may be included within the system such that a user may rate a business and other users would see the ratings given to the businesses by members of their direct networks (e.g., friends) and the social network as a whole.

In some embodiments, the system may take into account additional parameters such as time of day, day, hours of business operation, user velocity, and estimated time of travel to a given location. For example, a user driving on a highway submits a find request for a certain brand of coffee shop, and the closest match is 200 yards away, but the next available exit off of the highway is six miles away. The system may be configured to estimate a travel time to the location that takes into account the available travel routes for traveling to the location when determining which locations to recommend to the user. Time of day, day, and hours of business operation also may be taken into account to avoid providing recommendations that could send a user to a business that is closed.

When a user is visible to persons, they can be visible in one or more of several modes. They can be visible only to direct friends in their social network. They can be visible to friends-of-friends, or friends-of-friends-of-friends, etc. out to a number of levels which they specify. They may also create other constraints relative to age, gender interests, and membership in affinity groups (as opposed to explicit friends). Users may also characterize themselves in terms of “I am looking for . . . ” and can finish this sentence with things like “conversation”, “love”, “a game of basketball”, etc. The constraints on visibility may be set up through the profile set-up process, and users could pick one of a number of profiles that describe their current interest (which may include more than one item out of a check box list).

A social network system which takes geographic location into account may be deployed as an extension to an existing social network or as a stand-alone network. The system may provide drop-in elements that can be built into a social network member's home page, or fed (e.g., RSS) to pages of friends or others that choose to subscribe, in order to show current location of an individual of interest or more context specific information such as the distance between the individual of interest and the user looking at the page, for example. In embodiments where the system is integratable with existing electronic social networks, a user may be able to integrate with multiple existing electronic social networks by running multiple instances on one device with each instance being linked to a different social network. A single instance may be linked to more than one social network.

In some embodiments, a user's profile and preferences may be set up on a personal computer, and a limited or simplified number of parameters may be selected on a mobile device (e.g., a mobile phone, a mobile PDA, a dedicated mobile social network device). Examples of parameters that may be set on a mobile device in some embodiments include selecting a profile of relevance, setting the user's status to one of off, visible or invisible, establishing search radii, and sending and receiving specific notices. In some embodiments, all of the set-up activities may be performed on a mobile device.

The various databases and analysis software and/or other analysis features may be provided on a server or servers, and the one or more mobile devices carried by users in some embodiments may function primarily as communication and message input/output devices, as well as location establishment devices. For example, each user may carry a GPS-enabled device which determines the location of the user and communicates this location via a wireless communications network to the server(s). The server(s) track the users' locations and analyze the preferences and characteristics (including locations). When the server(s) discover a match between one user's preferences and another user's characteristics, appropriate messages or other communications may be sent to a mobile communication device of one or more users via a communications network. In some embodiments, a user may select to receive communications on a stationary device, such as PC instead of, or in addition to, a mobile device.

To provide revenue from the system, fees could be charged to the social networks which host the system. Advertising revenue may be shared with the social networks. Pop-up advertisements or other advertisements may be used on system websites. Partnerships may be established with companies that wish to push notices to users. Fees may be charged to companies which are presented to users who enter certain find requests. These fees may be based on certain time periods or on number of notices.

A partnership with a business phone or local search directory may be established where the social network acts as a type of search engine the ports to the phone directory. Partnership may be formed with mobile carriers with regard to conference call related revenue or SMS/voicemail revenue. In some embodiments, users could be charged when they send “specific” notices out to groups of geographically- and affinity-proximate users, as opposed to when they just want to see who is in a certain range of geographical proximity and has a certain level of profile match.

Extension of the network's reach temporally and geographically may provide various advantages. Geographically, in addition to the actual physical position of the user being taken into account for the various actions disclosed herein, in some embodiments, users may set up a “virtual presence.” To establish a virtual presence, a user defines a geographic location, such as by tagging a location on a map, and the system is instructed to behave as if the user's profile were present at the tagged geographic location instead of their actual current location. For example, a first user could set up a virtual presence outside of a favorite nightclub and interact with users that come within some distance of that virtual presence as if the first user were there (though the users would see the first user as being virtually there as opposed to actually there). Users could explicitly choose to be invisible to another user's virtual presence if they so desired. A user may have a profile virtually located at several geographic locations simultaneously, and/or a user may have different profiles located at the same or different geographic locations simultaneously.

In other examples, a user could set up a personal or professional network using the virtual presence feature. A business could monitor who was entering a competitor's store, and see various demographic information. The virtual presence feature could provide a method for initiating chats from your desktop with people, who, for example, are attending a Stanley Cup Finals game in Edmonton, or who are at some other event or place. A user could “capture” all of the people who the virtual presence detected, and create an affinity group or a new friends list (if the other people accepted) for later use.

Regarding a temporal extension of embodiments of the network, historical information regarding users' geographic location may be stored, preferences could be used to build an affinity group based on places where users have been and/or are currently present. For example, a user could build an affinity group by selecting everyone who had attended a concert of a specific band and had been to a specific sporting event by setting preferences for the appropriate dates, times and locations for these past events.

Similarly, embodiments of the system may be configured to facilitate future in-person meetings at specific locations. A user may indicate his or her intention to be at a given location at a time in the future and/or may search future times to see who is planning to be present at a given place in the future. A third party website may install a small piece of functionality on its own website such that site visitors can assess future participation in upcoming events.

For example, a user may post her intention to participate in an open ice hockey session on certain weekdays from 12-2. She also may be able to see how many other users have posted their intention to be present as well. The entries may contain information about the user, time, and location (for example, GPS-related information). The entries may be embedded into the electronic social network such that the visibility of intended future locations could be set by user preferences. The entries could be entered as part of an integrated calendar system such as Microsoft Outlook.

This virtual presence feature could give rise to sophisticated demographic data and analytics that could drive commercial opportunities. Extending the network system to include an analysis of geographic locations at which the user is not necessarily actually present and/or times other than the present may be desirable for various users. In short, the use of a virtual presence (which alternatively may be called listening posts and transmitting posts), in conjunction with historical, current and indicated future location information, may permit a relevant set of connections to be forged for both individual users and businesses participating in the system.

For example, a user may enter a preference which indicates a geographic location parameter and an associated time parameter. The location parameter and/or the time parameter may include an exact data point, or may include a range. For example, a user may enter a preference that indicates 100 Main Street at 11 o'clock am on February 7. Or, in some cases, the user may enter a location that includes 100 Main Street and a location radius of half a mile at 10 o'clock am through noon on February 7. In still other cases, the user may enter a number of discrete time ranges to be associated with one or more geographic locations. The time parameters associated with a location may be entirely or partially in the past, encompass the present time, or be entirely or partially in the future. The network system may then analyze the preferences indicated by the user relative to the characteristics of one or more other user profiles. For example, if the preference entered by the user indicates a geographic location and an associated time period of the present time through two hours later, the system may check the present location of other user profiles and additionally check any indicated future locations (during the next two hours) provided by other users. In this manner, the network system discovers matches across two or three-dimensional space and time.

For a particular user, locations associated with times in the past may be explicitly entered by the user, or an on-going timeline may automatically be stored by the network system based on location detection.

In some embodiments, a user may configure her user profile location characteristic (either her actual location or virtual presence) to include a range for one or both of a geographic location parameter and an associated time parameter. In this manner, the user expands her location and is more likely to match with listening posts or other users' preferences. For example, a first user may enter a transmitting post which includes a geographic location of 200 Main Street with a radius of 200 feet and an associated time of between noon and 2 o'clock pm on a specific Saturday. A second user may set up a listening post for 190 Main Street with a radius of 20 feet between 1 and 5 o'clock pm on the same Saturday. Even though the listening post (with a radius of only 20 feet) would not capture a transmitting post having a single-point location at 200 Main Street, the 200 foot radius of the first user's transmitting post allows the system to discover the location and time overlap. Depending on the users' preferences, the system may initiate a communication to one or both of the users. Similarly, instead of setting up a transmitting post with a location and/or time range, the first user may configure her profile to broadcast her actual location to include a radius (or other type of two-dimensional or three-dimensional range) and/or configure her profile to include a time lag. In this manner, her presence as she moves around is larger than a single point, and her “present location” may include a progressive trail that represents her location for the past hour, for example.

As described above, a user may indicate that her physical presence or her virtual presence is associated with a location and a time. For purposes herein, indicating whether a user's physical presence is associated with a certain geographic location at a certain time can include several different indication possibilities. For example, a user may indicate that she is physically present at the geographic location at the present time, or she may indicate that she is not physically present at the geographic location at the present time. Another possibility is for the user to indicate that she was (or alternatively, was not) physically present at the geographic location at past time. Another possible indication includes indicating that she plans to be (or alternatively, plans to not be) present at the geographic location at a future time.

The methods and systems disclosed herein may be implemented through a mobile phone application on a global positioning (GPS) radio or other suitable existing mobile device. For example, a user who already owns a mobile phone or other wireless device may be able to take advantage of the full functionality of the system with the addition of a simple device that is both GPS-enabled and configured to communicate GPS positioning data via a mobile phone network or other wireless network. Communications that are transmitted from a central server to the user may take place via the user's regular mobile phone or other wireless device. In this manner, in some embodiments, no communication need take place between a user's devices, and the only additional hardware carried by the user is a simple, low-cost device. Similarly, communications that are sent by the user to the central server may be initiated on the user's already-owned wireless device and/or PC. For example, a user may set preferences, characteristics, on-going pull requests from a PC, receive notifications via their wireless device (e.g., in the form of emails, SMS messages, web pages, web links, 15 automated inbound phone calls, etc.), and respond to the central server via the same wireless device. The preferred device for each of these steps may be selected and changed by the user. From the user's standpoint, the only new piece of hardware is a GPS-enabled device that communicates with the central server. Of course in some embodiments, the various pieces of hardware may communicate directly with one another, or a user may use a single mobile device that is GPS-enabled.

The GPS-enabled device need not have a direct line of sight to the sky, and can be outfitted with a long-life battery. In some embodiments, a GPS-enabled device communicates with the internet via a separate mobile phone via Bluetooth, a cable, or any other suitable connection. Embodiments of the system may be integrated with GPS software to help a user travel to a specific location. Physical positioning systems other than GPS may be used, for example, systems which locate users using mobile phone signals or WiFi or WiMAX, etc. signals.

In other embodiments, a GPS or other physical positioning system-enabled device may use a cellular phone network or a pager network and include some additional functionality. For example, the device may show text messages, and it may inform the user of conference line telephone numbers to use. Step-by-step directions to travel to a locale may also be downloaded to the unit through the pager or cellular phone network or local WiFi or WiMAX network, the directions having been generated off-line. In some embodiments, the user may manually enter his or her current location (e.g., an address) via a keyboard or keypad.

The rate at which physical locations are communicated back to a central server may be paced automatically by the system as a function of one or more variables. For example, the rate of location communication may be based on one or more of location, rate of change of location, time of day, which profile or profiles are active for the user, the visible/invisible state of the user, and/or additional variables. This approach may save energy on the device and may save cost for the user and/or the network. In some embodiments, the user may set the rate at which location information is communicated, whether the communications occur via SMS, email or other manners.

Various embodiments are described below with reference to the figures to show examples of systems and methods that may be implemented according to various aspects of the invention. Not every aspect of the various embodiments is required to implement embodiments of the invention, and additional components, acts or elements may be added and still fall within the scope of the invention. Additionally, various aspects of the embodiments may be combined.

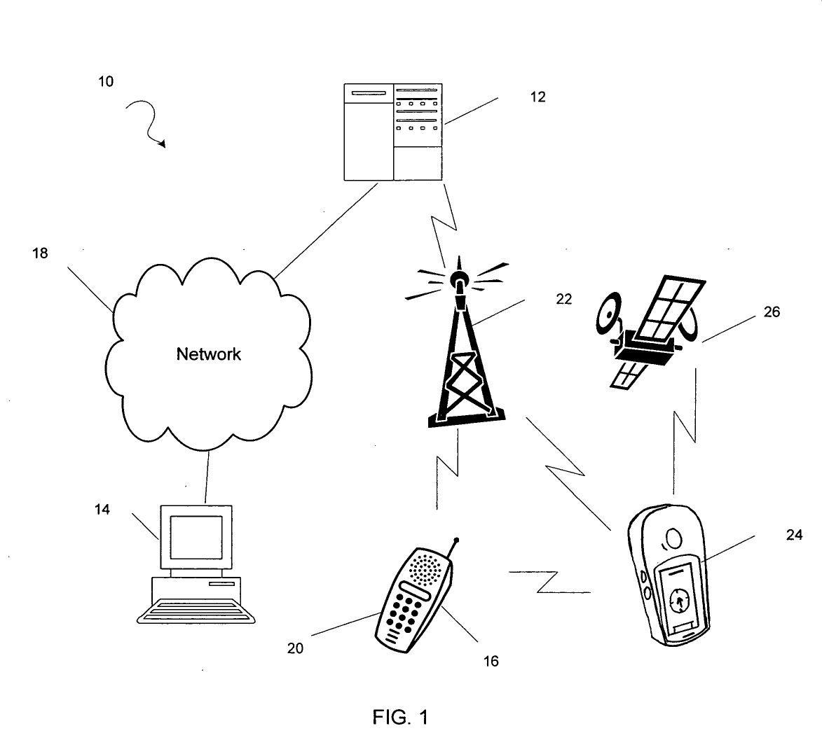

One embodiment of a system 10 which may be used to implement a mediated social network is illustrated in FIG. 1. A main server 12 receives various information from a plurality of users, searches for matches, and notifies users of found matches. In some embodiments, main server 12 may be implemented across a plurality of distributed servers. To use the social network, a user may provide preferences and/or characteristics to main server 12 using a computer 14, a mobile communication device such as a mobile telephone 16, or any other suitable device or method. In the case of computer 14, the user may enter information and communicate the information to main server over a suitable network 18, such as the internet. In the case of mobile telephone 16, the user may enter information using a keypad 20 as a user interface, and communicate the information using a mobile wireless network 22.

The mobile communication device, such as mobile telephone 16, may be used to receive messages from main server 12 and/or other users. For example, SMS messages, voice messages, e-mail messages and/or other suitable communications may be received by the mobile communication device. In some embodiments, a user may use a non-portable device such as computer 14 to receive communications such as e-mail messages or instant messages.

A location positioning device 24, used as part of a positioning system 26, such as GPS, may be used to determine a user's geographic location. Location information may be communicated to main server 12 via the same communication device carried by the user (e.g., mobile telephone 16), or may be communicated via the location positioning device (or system) itself. The location information may be communicated via an entirely different network.

In some embodiments, the communication device (e.g., mobile telephone 16) and location positioning device 24 may be physically separate devices, as shown in FIG. 1. The separate devices may communicate directly with each other and/or with main server 12 via the same or different wireless networks. In some embodiments, the communication device and location positioning device 24 may be incorporated within one physical entity. In such embodiments, communications with main server 12 may be via a single wireless network, or may be via more than one wireless network.

For purposes herein, the phrase “receive from a user” or “configured to receive from a user” is not limited to receiving an input, indication, or other data directly from a user. The information received from a user may pass through various intermediaries such as processors, memory, communications systems, etc.

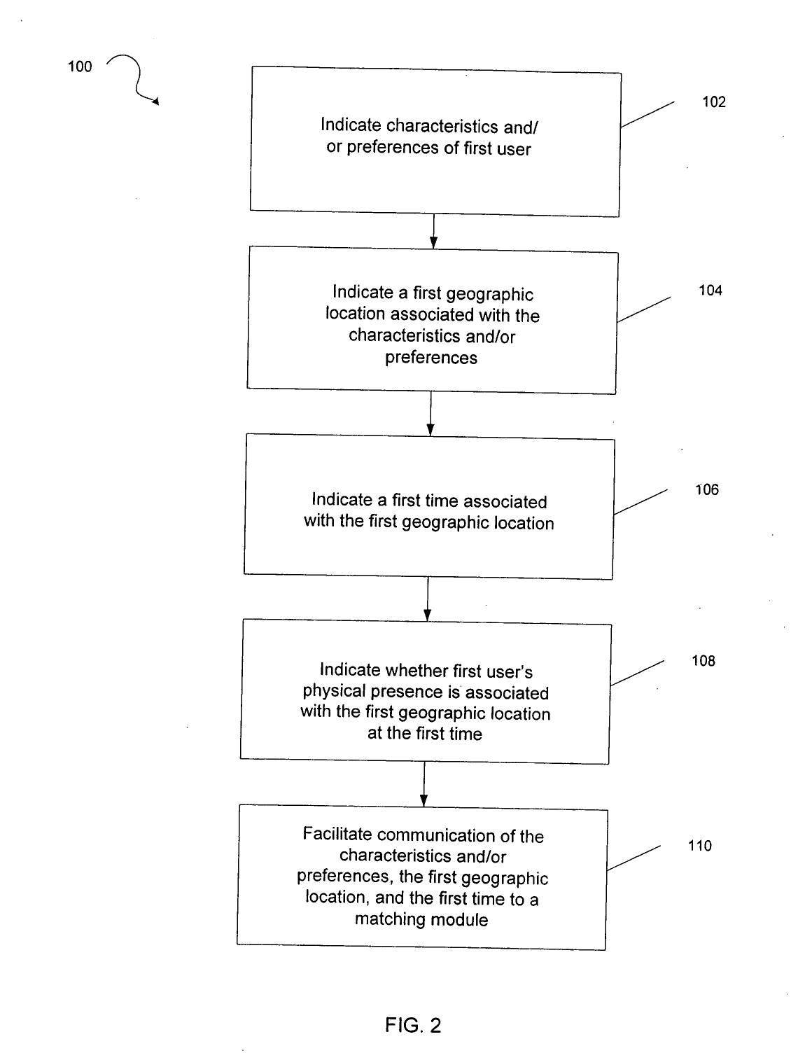

According to one embodiment, a method 100 of sending various indications to a matching module is shown in FIG. 2. In a first act 102, characteristics and/or preferences of a first user are indicated. This indication may be performed via a user interface and may be performed by the first user. In an act 104, a first geographic location associated with the characteristics and/or preferences of the first user is indicated. As above, this indication may be performed by a first user, however, this indication may be performed by other than the first user. For example, a location device, such as a handheld GPS device may automatically indicate a geographic location. In an act 106, a first time associated with the first geographic location is indicated. The first user may indicate this time via a user interface, or, in some embodiments, the time may be automatically indicated by a clock. The time may be indicated at, prior to, or after the time indicated. In other words, the indicated time may be a present time, a time in the future, or a time in the past.

In an act 108, an indication is provided as to whether the first user's physical presence is associated with the first geographic location at the first time. For example, a first user may provide the indications of acts 102 through 106 and further indicate that his virtual presence is associated with the geographic location and associated time. In this manner, the user is indicating that her physical presence is not associated with the location and time. Conversely, a user may explicitly indicate that her physical presence is associated with the location and time. In this manner, a matching module and/or other users may use this information to find matches among users specifying that they only want a match to be achieved when physical presence (as opposed to virtual presence) exists.

In the case of a past time, the indication whether the user's physical presence is associated with the location and time includes an indication by the user or a database that the user was physically present at the location at the past time. In the case of the present time, the indication as to whether the user is currently physically present may be provided by the user or may be provided by a location device acting in concert with a geographic locating system such as GPS. In the case of a future time, the indication as to physical presence may be provided by the user.

It should be noted that acts 102 through 110 do not necessarily have to occur close in time or in the sequence depicted. For example, a first user may indicate a geographic location and an associated future time, and several weeks later indicate a characteristic.

In an act 110, communication of some or all of the indications provided in acts 102 through 110 to a matching module is facilitated. The matching module may be configured to compare the first geographic location, the first time, and at least one of the first user's preferences and the first user's characteristics, to: a second geographic location of a second user, a second time associated with the second geographic location, and at least one of preferences and characteristics of a second user. This comparison may be made to determine whether a match exists between the first user and the second user.

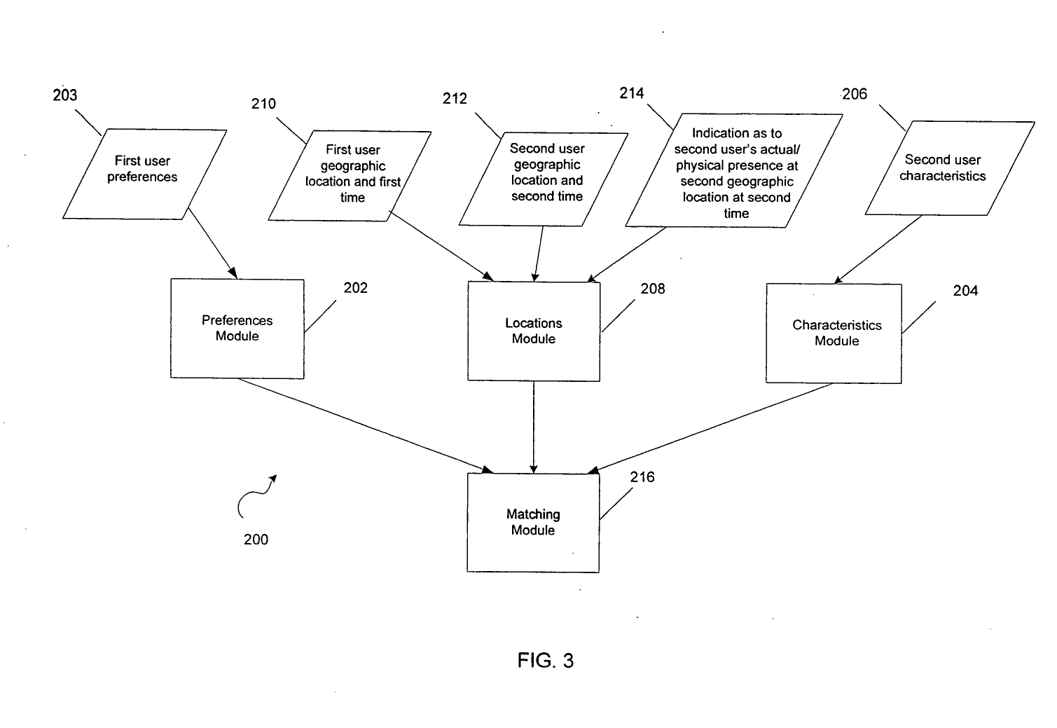

One embodiment of an electronic social network system 200 is illustrated in FIG. 3. System 200 includes a preferences module 202 configured to receive preferences 203 of a first user. A characteristics module 204 is configured to receive characteristics 206 of a second user. A locations module 208 is configured to receive, from the first user, information 210 including a first geographic location associated with the preferences of the first user, and a first time associated with the first geographic location. Similarly, locations module 208 is configured to receive, from the second user, information 212 including a second geographic location associated with the characteristics of the second user and a second time associated with a the second geographic location. Locations module 208 is also configured to receive an indication 214 as to the second user's actual physical presence at the second geographic location at the second time.

System 200 includes a matching module 216 configured to determine whether a match exists between the first user and the second user. The determination of whether a match exists includes comparing the preferences of the first user to the characteristics of the second user, and comparing the first geographic location and the first time to the second geographic location and the second time.

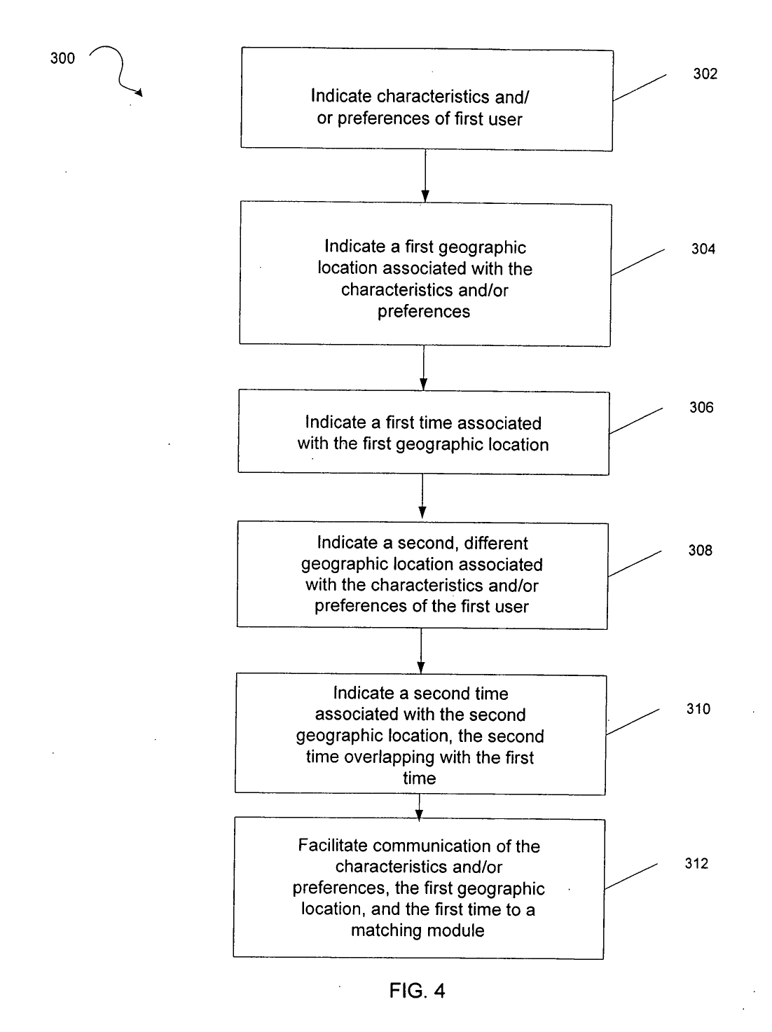

In another embodiment, illustrated in FIG. 4, a method 300 permits a user to maintain two “presences” simultaneously. Method 300 includes an act 302 of indicating via a user interface, a plurality of characteristics of a first user, and/or a plurality of preferences of the first user. A first geographic location associated with the characteristics and/or preferences of the first user is indicated in an act 304. In an act 306, a first time associated with the first geographic location is indicated. A second geographic location associated with the characteristics and/or preferences of the first user is indicated in an act 308. In this embodiment, the second geographic location is different from the first geographic location. In an act 310, a second time associated with the second geographic location is indicated, and the second time overlaps with the first time.

One or more communications to a matching module are facilitated in an act 312. The one or more communications may include the characteristics of the first user and/or the preferences of the first user, the first geographic location, the first time, the second geographic location, and the second time. According to this embodiment, the matching module is configured to compare the first geographic location, the first time, the second geographic location, the second time, and the characteristics and/or the preferences of the first user, to characteristics and/or preferences of a second user, a third geographic location associated with the characteristics and/or preferences of the second user, and a third time associated with the third geographic location. Additionally, the matching module is configured to simultaneously maintain the first geographic location and the first time, and the second geographic location and the second time as actively available for comparison to at least the third geographic location and the third time.

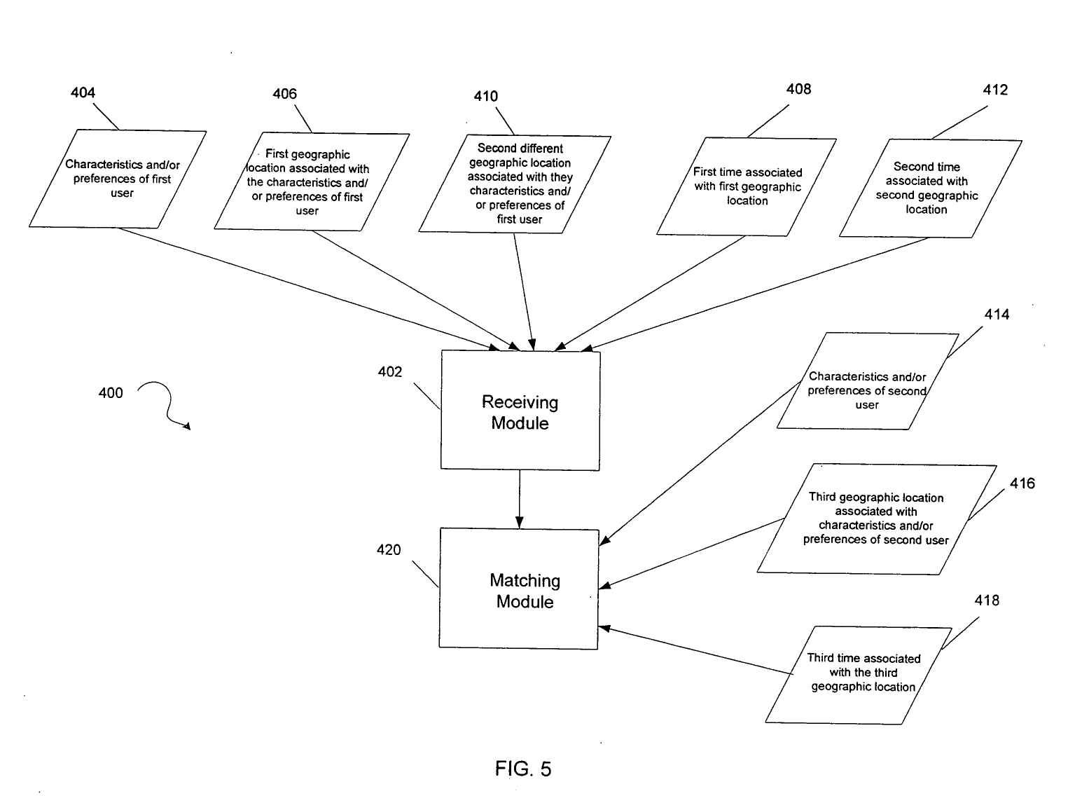

In FIG. 5, one embodiment of an electronic social network system 400 which compares two simultaneously maintained “presences” of a first user with one or more other users, is illustrated. System 400 includes a receiving module 402 configured to receive various indications. For example, receiving module 402 may be configured to receive indication(s) 404 of characteristics and/or preferences of a first user. Receiving module 402 may be configured to further receive an indication 406 of a first geographic location associated with the characteristics and/or preferences of the first user and an indication 408 of a first time associated with the first geographic location. Receiving module 402 may be configured to receive an indication 410 of a second geographic location associated with the characteristics and/or preferences of the first user, with the second geographic location being different from the first geographic location. Additionally, receiving module 402 may be configured to receive an indication 412 of a second time associated with the second geographic location, with the second time overlapping with the first time.

Indications 414, 416 and 418 of characteristics and/or preferences of a second user, a third geographic location associated with the characteristics and/or preferences of the second user, and a third time associated with the third geographic location, may be provided to a matching module 420. These indications may be provided directly to matching module 420, or, in some embodiments, provided to matching module 420 via receiving module 402. In some embodiments, indications 414, 416, 418 already exist in matching module 420 before some or all of indications 404, 406, 408, 410 and 412 are provided to receiving module 402.

Matching module 420 is configured to compare: the first geographic location, the first time, the second geographic location, the second time, and the characteristics and/or the preferences of the first user, to the characteristics and/or preferences of a second user, the third geographic location associated with the characteristics and/or preferences of the second user, and the third time associated with the third geographic location. Matching module 420 is configured to simultaneously maintain the first geographic location and the first time, and the second geographic location and the second time as actively available for comparison to at least the third geographic location and the third time. In this manner, the first user can maintain two separate “presences” at the same time, each of which may be compared to a second user's location and associated time. For example, the first user may maintain one physical presence and one virtual presence in separate locations at the same time. In some cases, the first user may maintain two or more virtual presences at different locations at the same time.

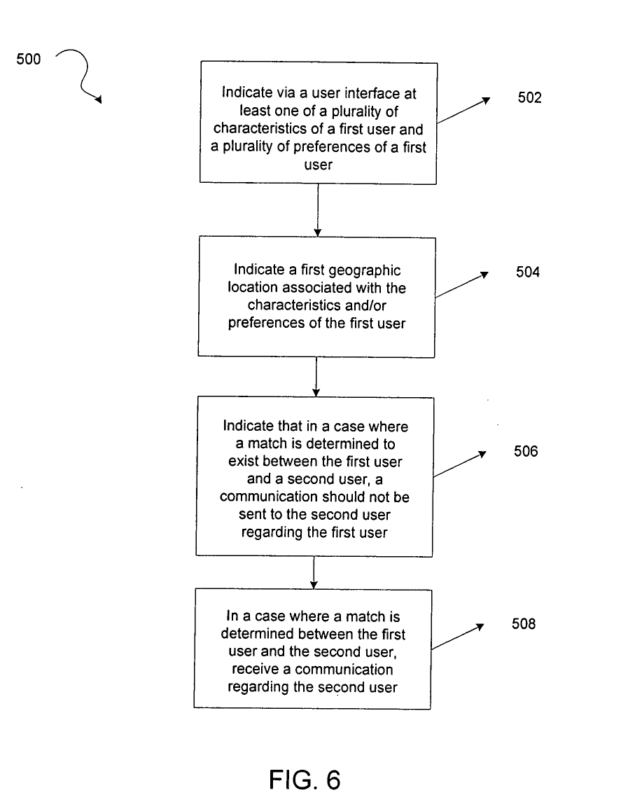

A method 500 of providing indications and receiving a communication is illustrated in FIG. 6. In method 500, a first user provides information to a social network, and an indication is provided that a second user, with whom the first user matches, should not be alerted as to the match. In this manner, the first user is invisible to the second user, but the first user is not off-line from the network.

In an act 502, characteristics and/or preferences of a first user are indicated via a user interface. A first geographic location associated with the characteristics and/or preferences of the first user is indicated in an act 504. In an act 506, it is indicated that in a case where a match is determined to exist between the first user and a second user, a communication should not be sent to the second user regarding the first user. In some embodiments, this indication is provided by the first user. In a further act 508, in a case where a match is determined between the first user and the second user, a communication regarding the second user is received. In some embodiments, this communication is received by the first user. In some embodiments, a match is a positive result of an analysis of the first geographic location, the characteristics and/or preferences of the first user, a second geographic location of the second user, and the characteristics and/or preferences of the second user.

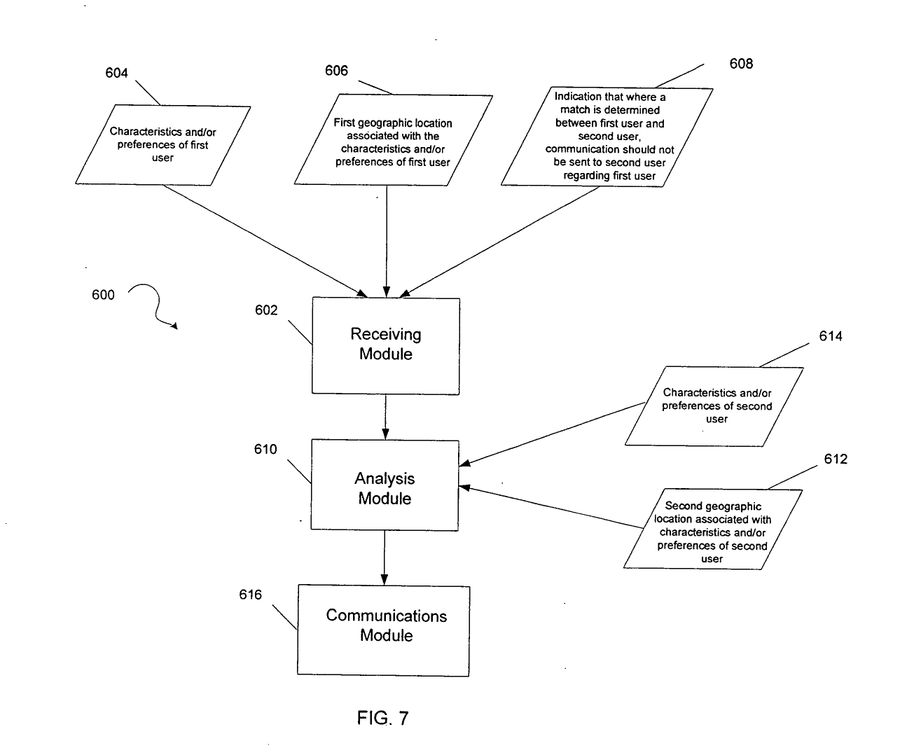

One embodiment of an electronic social network system 600 which may be configured allow a user to be in an invisible state is illustrated in FIG. 7. System 600 includes a receiving module 602 configured to receive an indication 604 of characteristics and/or preferences of a first user, and an indication 606 of a first geographic location associated with the characteristics and/or preferences of the first user. The receiving module is further configured to receive an indication 608 that in a case where a match is determined to exist between the first user and a second user, a communication should not be sent to the second user regarding the first user.

System 600 further includes an analysis 610 module to be used as part of determining whether a match exists. Analysis module 610 is configured to analyze the first geographic location, the characteristics and/or preferences of the first user, a geographic location of the second user 612, and the characteristics and/or preferences of the second user 614. A communication module 616 is included in system 600 and is configured to send a communication regarding the second user to the first user in a case where a match is determined between the first user and the second user.

Particular implementation details of computer systems that may execute aspects of the invention will now be described. These implementation details are provided by way of example only, and the invention is not limited to any particular implementation.

Various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

Methods described herein, acts thereof and various embodiments and variations of these methods and acts, individually or in combination, may be defined by computer-readable messages tangibly embodied on or more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing.

Computer-readable messages embodied on one or more computer-readable media may define instructions, for example, as part of one or more programs that, as a result of being executed by a computer, instruct the computer to perform one or more of the functions described herein, and/or various embodiments, variations and combinations thereof. The computer-readable media on which such instructions are embodied may reside on one or more of the components of any of systems described herein, may be distributed across one or more of such components, and may be in transition therebetween. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

The computer-readable media may be transportable such that the instructions stored thereon can be loaded onto any suitable computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Various embodiments according to the invention may be implemented on one or more computer systems.

For example, various aspects of the invention may be implemented as specialized software executing in a general-purpose computer system, for example, on main server 12, computer 14, mobile telephone 16 and/or other devices. The computer system may include a processor connected to one or more memory devices, such as a disk drive, memory, or other device for storing data. Memory is typically used for storing programs and data during operation of the computer system. Components of the computer system may be coupled by an interconnection mechanism, which may include one or more busses (e.g., between components that are integrated within a same machine) and/or a network (e.g., between components that reside on separate discrete machines). The interconnection mechanism enables communications (e.g., data, instructions) to be exchanged between system components. The computer system also may include one or more input devices, for example, a keyboard, mouse, trackball, microphone, touch screen, or digitizing tablet and one or more output devices, for example, a printing device, display screen, speaker. In addition, the computer system may contain one or more interfaces that connect the computer system to a communication network (in addition or as an alternative to the interconnection mechanism.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

It should be appreciated that the invention is not limited to executing on any particular system or group of systems. Also, it should be appreciated that the invention is not limited to any particular distributed architecture, network, or communication protocol.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method comprising:
indicating via a user interface at least one of: a) a plurality of characteristics of a first user; and b) a plurality of preferences of a first user;
indicating a first geographic location associated with the characteristics and/or preferences of the first user;
indicating a first time associated with the first geographic location;
indicating whether the first user's physical presence is associated with the first geographic location at the first time; and
facilitating communication of the plurality of the first user's characteristics and/or the plurality of the first user's preferences, the first geographic location, and the first time to a matching module, the matching module being configured to compare:
the first geographic location, the first time, and at least one of: a) the first user's preferences; and b) the first user's characteristics to
a second geographic location of a second user, a second time associated with the second geographic location, and at least one of preferences and characteristics of a second user,
in order to determine whether a match exists between the first user and the second user.

2. The method of claim 1, wherein indicating the first time comprises indicating a time comprising a future time.

3. The method of claim 1, wherein indicating the first time comprises indicating a time comprising the present time.

4. The method of claim 1, wherein indicating the first time comprises indicating a time comprising a past time.

5. The method of claim 1, wherein indicating the first time comprises indicating a first time range, and wherein the second time comprises a second time range.

6. The method of claim 1, wherein the matching module is configured to compare:
the first geographic location, the first time and at least one of: a) the first user's preferences; and b) the first user's characteristics to
geographic locations of a plurality of users, times associated with the geographic locations of the plurality of users, and at least one of preferences and characteristics of a plurality of users.

7. The method of claim 1, wherein indicating the first geographic location comprises indicating a geographic location that is determined using a portable position element that is used as part of a geographic location determination system.

8. The method of claim 1, wherein indicating the first time comprises inputting a time via a user interface.

9. The method of claim 1, wherein indicating the first time comprises indicating a time in the future.

10. The method claim 1, wherein indicating the first time comprises providing the present time from a time device.

11. The method of claim 2, wherein indicating whether the first user's physical presence is associated with the first geographic location at the first time comprises indicating that the first user plans to not be physically present at the first geographic location at the first time.

12. The method of claim 3, wherein indicating whether the first user's physical presence is associated with the first geographic location at the first time comprises indicating that the first user is not physically present at the first geographic location at the present time.

13. The method of claim 4, wherein indicating whether the first user's physical presence is associated with the first geographic location at the first time comprises indicating that the first user was not present at the first geographic location at the first time.

14. The method as in claim 2, further comprising indicating when the first user is to receive a communication alerting the first user to a match between the first user and the second user.

15. The method as in claim 14, wherein indicating when the first user is to receive a communication alerting the first user to a match between the first user and the second user comprises indicating that the first user is to receive a communication after the matching module determines that a match exists, and before the first time and the second time overlap.

16. The method as in claim 14, wherein indicating when the first user is to receive a communication alerting the first user to a match between the first user and the second user comprises indicating that the first user is to receive a communication when the first time and the second time overlap.

17. The method as in claim 1, wherein the matching module is configured to compare the first geographic location and the first time to the second geographic location, and the second geographic location has been indicated to be a geographic location to which the second user's physical presence is not associated at the second time.

18. The method as in claim 2, further comprising indicating when the second user is to receive a communication alerting the second user to a match between the first user and the second user.

19. The method as in claim 18 wherein the first user performs the act of indicating when the second user is to receive a communication alerting the second user to a match between the first user and the second user.

20. The method as in claim 18 wherein the second user performs the act of indicating when the second user is to receive a communication alerting the second user to a match between the first user and the second user.

21. The method as in claim 1, further comprising indicating that the second user is not to receive a communication alerting the second user to a match between the first user and the second user.

22. An electronic social network system comprising:
a preferences module configured to receive preferences of a first user;
a characteristics module configured to receive characteristics of a second user;
a locations module configured to receive, from the first user, a first geographic location associated with the preferences of the first user, and a first time associated with the first geographic location;
the locations module configured to further receive, from the second user, a second geographic location associated with the characteristics of the second user, a second time associated with a the second geographic location, and an indication as to the second user's actual physical presence at the second geographic location at the second time; and
a matching module configured to determine whether a match exists between the first user and the second user, wherein the determination includes comparing the preferences of the first user to the characteristics of the second user, and comparing the first geographic location and the first time to the second geographic location and the second time.

23. The system as in claim 22, wherein the locations module is configured to further receive an indication as to the first user's actual physical presence at the first geographic location at the first time.

24. The system as in claim 22, wherein the determination further includes comparing the preferences of the first user to the indication as to the second user's actual physical presence at the second geographic location at the second time.

25. The system as in claim 22, wherein the first time comprises a future time, and the indication as to the second user's actual physical presence at the second geographic location at the second time comprises an indication as to whether the second user intends to be present at the second geographic location at the future time.

26. The system as in claim 22, wherein the second time comprises the present time, and the indication as to the second user's actual physical presence at the second geographic location at the second time comprises an indication as to whether the second user is present at the second geographic location at the present time.

27. The system as in claim 22, wherein the second time comprises a past time, and the indication as to the second user's actual physical presence at the second geographic location at the second time comprises an indication as to whether the second user was present at the second geographic location at the past time.

28. The system as in claim 22, further comprising a communication module configured to initiate a communication to at least one of the first user and the second user in a case where the matching module determines that a match exists between the first user and the second user.

29. The system as in claim 28, wherein the communication comprises information regarding the second user's physical presence at the second geographical location, the information comprising at least one of: a) the indication by the second user as to the actual physical presence of the second user at the second geographic location; and b) the actual physical presence of the second user at the second geographic location as determined by a positioning system.

30. The system as in claim 28, wherein the preferences module is configured to receive an indication as to when to initiate the communication to the first user.

31. The system as in claim 28, wherein the preferences module is configured to receive an indication to initiate the communication to the first user after the matching module determines that a match exists, and before the first time and the second time overlap.

32. The system as in claim 28, wherein the preferences module is configured to receive an instruction to initiate the communication to the first user at a time when the first time and the second time overlap.

33. The system as in claim 22, wherein the characteristics module is configured to receive characteristics of the first user.

34. The system as in claim 22, wherein the preferences module is configured to receive preferences of the second user.

35. A method comprising:
indicating via a user interface at least one of: a) a plurality of characteristics of a first user; and b) a plurality of preferences of the first user;
indicating a first geographic location associated with the characteristics and/or preferences of the first user;
indicating a first time associated with the first geographic location;
indicating a second geographic location associated with the characteristics and/or preferences of the first user, the second geographic location being different from the first geographic location;
indicating a second time associated with the second geographic location, the second time overlapping with the first time; and
facilitating one or more communications to a matching module, the one or more communications comprising the characteristics of the first user and/or the preferences of the first user, the first geographic location, the first time, the second geographic location, and the second time; wherein
the matching module is configured to compare the first geographic location, the first time, the second geographic location, the second time, and the characteristics and/or the preferences of the first user to characteristics and/or preferences of a second user, a third geographic location associated with the characteristics and/or preferences of the second user, and a third time associated with the third geographic location; and
the matching module is configured to simultaneously maintain the first geographic location and the first time, and the second geographic location and the second time as actively available for comparison to at least the third geographic location and the third time.

36. The method of claim 35, wherein the matching module is configured to compare the first geographic location, the first time, the second geographic location, the second time, and the characteristics and/or the preferences of the first user to characteristics and/or preferences of a plurality of users, geographic locations associated with each of the plurality of users, and times associated with each of the geographic locations that are associated with each of the plurality of users.

37. The method of claim 35, wherein indicating a first time comprises indicating the present time and indicating the second time comprises indicating the present time.

38. The method of claim 35, wherein indicating a first time comprises indicating a time range that starts with the present time.

39. The method of claim 38, wherein indicating a time range that starts with the present time comprises indicating a time range that does not expire until an affirmative act is performed at a future time.

40. The method as in claim.35, wherein indicating the first time comprises indicating a future time.

41. The method as in claim 35, wherein indicating the first time comprises indicating the present time.

42. The method as in claim 35, wherein indicating the first time comprises indicating a past time.

43. The method as in claim 35, wherein indicating at least one of: a) a plurality of characteristics of a first user; and b) a plurality of preferences of a first user comprises indicating a plurality of preferences of a first user.

44. The method as in claim 35, wherein indicating at least one of: a) a plurality of characteristics of a first user; and b) a plurality of preferences of a first user comprises indicating a plurality of characteristics of a first user.

45. The method as in claim 35, wherein indicating at least one of: a) a plurality of characteristics of a first user; and b) a plurality of preferences of a first user comprises indicating a plurality of characteristics of a first user and a plurality of preferences of a first user.

46. The method of claim 45, further comprising indicating that initiating a communication to a second user based on a match between the first user's characteristics and the second user's preferences is not permitted.

47. The method of claim 45, further comprising indicating that initiating a communication to a second user based on a match between the first user's characteristics and the second user's preferences is permitted.

48. The method of claim 46, further comprising receiving a communication which indicates that a match has been found based at least on: the first user's characteristics, the second user's preferences, at least one of the first and second geographic locations, at least one of the first and second times, a geographic location indicated by the second user, and a time indicated by the second user.

49. The method of claim 48, further comprising responding to the communication.

50. An electronic social network system comprising:
a receiving module configured to receive indications of:
at least one of: a) a plurality of characteristics of a first user; and b) a plurality of preferences of the first user;
a first geographic location associated with the characteristics and/or preferences of the first user;
a first time associated with the first geographic location;
a second geographic location associated with the characteristics and/or preferences of the first user, the second geographic location being different from the first geographic location; and
a second time associated with the second geographic location, the second time overlapping with the first time;
a matching module configured to compare:
the first geographic location, the first time, the second geographic location, the second time, and the characteristics and/or the preferences of the first user to
characteristics and/or preferences of a second user, a third geographic location associated with the characteristics and/or preferences of the second user, and a third time associated with the third geographic location;
wherein the matching module is configured to simultaneously maintain the first geographic location and the first time, and the second geographic location and the second time as actively available for comparison to at least the third geographic location and the third time.

51. A method comprising:
indicating via a user interface at least one of: a) a plurality of characteristics of a first user; and b) a plurality of preferences of a first user;
indicating a first geographic location associated with the characteristics and/or preferences of the first user;
indicating that, in a case where a match is determined to exist between the first user and a second user, a communication should not be sent to the second user regarding the first user; and
in a case where a match is determined between the first user and the second user, receiving a communication regarding the second user; wherein
a match comprises a positive result of an analysis of the first geographic location, the characteristics and/or preferences of the first user, a second geographic location of the second user, and the characteristics and/or preferences of the second user.

52. An electronic social network system comprising:
a receiving module configured to receive:
an indication of at least one of: a) a plurality of characteristics of a first user; and b) a plurality of preferences of a first user;
an indication of a first geographic location associated with the characteristics and/or preferences of the first user;
an indication that in a case where a match is determined to exist between the first user and a second user, a communication should not be sent to the second user regarding the first user;
an analysis module to be used as part of determining whether a match exists, the analysis module configured to analyze the first geographic location, the characteristics and/or preferences of the first user, a second geographic location of the second user, and the characteristics and/or preferences of the second user; and
a communication module configured to send a communication regarding the second user to the first user in a case where a match is determined between the first user and the second user.

53. A portable system for use as part of a social network system, the portable system comprising:
a location positioning device, used as a part of positioning system, to provide the location of the location positioning device to a main server;
a communication device configured to communicate with the main server; and
an interface with the communication device configured to receive indications of:
a first geographic location associated with characteristics and/or preferences of a first user;
a first time associated with the first geographic location; and
whether the first user's physical presence is associated with the first geographic location at the first time.

54. The portable system of claim 53, wherein the location positioning device and the communication device comprise physically separate devices.

55. The portable system of claim 54, wherein the user interface is positioned on the location positioning device.

56. The portable system of claim 54, wherein the user interface is positioned on the communication device.

57. The portable system of claim 53, wherein the location positioning device and the communication device are incorporated within one physical assembly.

58. The portable system of claim 57, wherein the communication device and the location positioning device are configured to communicate with the main server via the same communications network.

59. The portable system of claim 57, wherein the communication device is configured to communicate with the main server via a communications network that different than the communications network with which the location positioning device is configured to communicate with the main server.

60. The portable system of claim 53, wherein the communication device is configured to communicate with the main server via at least one of: a cellular telephone network; a WiMAX network; and a WiFi network.

61. A portable system for use as part of a social network system, the social network system including a main server that is configured to determine whether a match exists between various users based on the locations of the users, the portable system comprising:
a location positioning device, used as a part of positioning system, to provide the location of the location positioning device to a main server;
a user interface configured to receive an indication that in a case where a match is determined to exist between the first user and a second user, a communication should not be sent to the second user regarding the first user; and
a communication device configured to send the indication to the main server and further configured to receive a communication from the main server in the case of a match being determined to exist between the first user and a second user.

62. The portable system of claim 61, wherein the location positioning device and the communication device comprise physically separate devices.

63. The portable system of claim 61, wherein the location positioning device and the communication device are incorporated within one physical assembly.
